(19) United States
(12) Patent Application Publication
(10) Pub. No.: US 2008/0088619 A1
(43) Pub. Date: Apr. 17, 2008

(54) Branch Prediction for Acceleration Data Structure Traversal

(76) Inventors: Robert Allen Shearer, Rochester, MN (US); Alfred Thomas Watson, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/550,020

(22) Filed: Oct. 17, 2006

(51) Int. Cl. G06T 17/00

(52) U.S. Cl. 345/420; 345/421

(57) ABSTRACT

Embodiments of the invention provide methods and apparatus for pre-fetching bounding volume information while tracing a ray through a spatial index. According to one embodiment of the invention, a first ray may be traced through a spatial index and a traversal history may be recorded. Later, a subsequent ray may be issued into a three dimensional scene which may have a similar trajectory as the first ray. The subsequent ray may intersect the same bounding volumes as the first ray as it is traversed through the spatial index. Therefore, the recorded traversal history may be used to pre-fetch bounding volume information while traversing the subsequent ray through the spatial index. By pre-fetching the bounding volume information, the amount of time to traverse the subsequent ray through the spatial index may be reduced.

### BACKGROUND OF THE INVENTION

1. Field of the Invention

Embodiments of the invention generally relate to the field of computer processing.

2. Description of the Related Art

The process of rendering two-dimensional images from three-dimensional scenes is commonly referred to as image processing. As the modern computer industry evolves image processing evolves as well. One particular goal in the evolution of image processing is to make two-dimensional simulations or renditions of three-dimensional scenes as realistic as possible. One limitation of rendering realistic images is that modern monitors display images through the use of pixels.

A pixel is the smallest area of space which can be illuminated on a monitor. Most modern computer monitors will use a combination of hundreds of thousands or millions of pixels to compose the entire display or rendered scene. The individual pixels are arranged in a grid pattern and collectively cover the entire viewing area of the monitor. Each individual pixel may be illuminated to render a final picture for viewing.

One technique for rendering a real world three-dimensional scene onto a two-dimensional monitor using pixels is called rasterization. Rasterization is the process of taking a two-dimensional image represented in vector format (mathematical representations of geometric objects within a scene) and converting the image into individual pixels for display on the monitor. Rasterization is effective at rendering graphics quickly and using relatively low amounts of computational power; however, rasterization suffers from some drawbacks. For example, rasterization often suffers from a lack of realism because it is not based on the physical properties of light, rather rasterization is based on the shape of three-dimensional geometric objects in a scene projected onto a two dimensional plane. Furthermore, the computational power required to render a scene with rasterization scales directly with an increase in the complexity of the scene to be rendered. As image processing becomes more realistic, rendered scenes also become more complex. Therefore, rasterization suffers as image processing evolves, because rasterization scales directly with complexity.

Another technique for rendering a real world three-dimensional scene onto a two-dimensional monitor using pixels is called ray tracing. The ray tracing technique traces the propagation of imaginary rays, rays which behave similar to rays of light, into a three-dimensional scene which is to be rendered onto a computer screen. The rays originate from the eye(s) of a viewer sitting behind the computer screen and traverse through pixels, which make up the computer screen, towards the three-dimensional scene. Each traced ray proceeds into the scene and may intersect with objects within the scene. If a ray intersects an object within the scene, properties of the object and several other contributing factors are used to calculate the amount of color and light, or lack thereof, the ray is exposed to. These calculations are then used to determine the final color of the pixel through which the traced ray passed.

The process of tracing rays is carried out many times for a single scene. For example, a single ray may be traced for each pixel in the display. Once a sufficient number of rays have been traced to determine the color of all of the pixels which make up the two-dimensional display of the computer screen, the two dimensional synthesis of the three-dimensional scene can be displayed on the computer screen to the viewer.

Ray tracing typically renders real world three dimensional scenes with more realism than rasterization. This is partially due to the fact that ray tracing simulates how light travels and behaves in a real world environment, rather than simply projecting a three dimensional shape onto a two dimensional plane as is done with rasterization. Therefore, graphics rendered using ray tracing more accurately depict on a monitor what our eyes are accustomed to seeing in the real world.

Furthermore, ray tracing also handles increases in scene complexity better than rasterization as scenes become more complex. Ray tracing scales logarithmically with scene complexity. This is due to the fact that the same number of rays may be cast into a scene, even if the scene becomes more complex. Therefore, ray tracing does not suffer in terms of computational power requirements as scenes become more complex as rasterization does.

One major drawback of ray tracing is the large number of calculations, and thus processing power, required to render scenes. This leads to problems when fast rendering is needed. For example, when an image processing system is to render graphics for animation purposes such as in a game console. Due to the increased computational requirements for ray tracing it is difficult to render animation quickly enough to seem realistic (realistic animation is approximately twenty to twenty-four frames per second).

Therefore, there exists a need for more efficient techniques and devices to perform ray tracing.

### SUMMARY OF THE INVENTION

Embodiments of the present invention generally provide methods and apparatus for performing ray tracing.

According to one embodiment of the invention a method of ray tracing utilizing a spatial index having nodes defining bounded volumes of a three dimensional scene is provided. The method generally comprising: issuing a first ray into the three dimensional scene; traversing the spatial index by taking branches from internal nodes until a leaf node is reached, wherein branches are taken based on whether the first ray intersects bounding volumes defined by the nodes; recording a history of traversal of the first ray; issuing a second ray into the three dimensional scene; pre-fetching information defining bounded volumes intersected by the first ray based on the history of traversal of the first ray; and traversing the spatial index by taking branches from internal nodes until a leaf node is reached, wherein branches are taken based on whether the second ray intersects bounding volumes defined by the nodes.

According to another embodiment of the invention a computer readable medium is provided. The computer readable medium containing a program which, when executed, performs an operation, generally comprising: issuing an first ray into the three dimensional scene; traversing the spatial index by taking branches from internal nodes until a leaf node is reached, wherein branches are taken based on whether the first ray intersects bounding volumes defined by the nodes; recording a history of traversal of the first ray; issuing a second ray into the three dimensional scene; pre-fetching information defining bounded volumes intersected by the first ray based on the history of traversal of the first ray; and traversing the spatial index by taking branches from internal nodes until a leaf node is reached, wherein branches are taken based on whether the second ray intersects bounding volumes defined by the nodes.

According to another embodiment of the invention a system is provided. The system generally comprising: a memory; and a processing element configured to: issue an first ray into a three dimensional scene; traverse a spatial index having nodes defining bounded volumes of the three dimensional scene by taking branches from internal nodes until a leaf node is reached, wherein branches are taken based on whether the first ray intersects bounding volumes defined by the nodes; record a history of traversal of the first ray; issue a second ray into the three dimensional scene; pre-fetch from memory information defining bounded volumes intersected by the first ray based on the history of traversal of the first ray; and traverse the spatial index by taking branches from internal nodes until a leaf node is reached, wherein branches are taken based on whether the second ray intersects bounding volumes defined by the nodes.

According to another embodiment of the invention a method of traversing a tree structure having nodes is provided. The method generally comprising: during a first traversal, traversing the tree structure by taking branches from nodes until a leaf node is reached, wherein branches are taken based on whether conditions defined by nodes are satisfied; recording a history of traversal of the spatial index; and during a second traversal, pre-fetching information defining nodes based on the recorded history of traversal of the spatial index, and traversing the tree structure by taking branches from nodes until a leaf node is reached, wherein branches are taken based on whether conditions defined by nodes are satisfied.

### BRIEF DESCRIPTION OF THE DRAWINGS

FIG. 1 illustrates a multiple core processing element, according to embodiments of the invention.

FIG. 2 illustrates multiple core processing element networks, according to embodiments of the invention.

FIG. 3 is an exemplary three dimensional scene to be rendered by an image processing system, according to one embodiment of the invention.

FIGS. 4A-4C illustrate a two dimensional space to be rendered by an image processing system and a corresponding spatial index created by an image processing system, according to embodiments of the invention.

FIG. 5 illustrates an exemplary pattern for issuing rays into a three dimensional scene, according to one embodiment of the invention.

FIG. 6 is a flowchart illustrating a method of traversing a spatial index and recording a branch history, according to one embodiment of the invention

FIGS. 7 and 9 illustrate a spatial index and a branch history table, according to one embodiment of the invention.

FIG. 8 is a flowchart illustrating a method of pre-fetching bounding volume data and updating a branch history table, according to one embodiment of the invention.

### DETAILED DESCRIPTION OF THE PREFERRED EMBODIMENTS

Embodiments of the invention provide methods and apparatus for pre-fetching bounding volume information while tracing a ray through a spatial index. According to one embodiment of the invention, a first ray may be traced through a spatial index and a traversal history may be recorded. Later, a subsequent ray may be issued into a three dimensional scene which may have a similar trajectory as the first ray. The subsequent ray may intersect the same bounding volumes as the first ray as it is traversed through the spatial index. Therefore, the recorded traversal history may be used to pre-fetch bounding volume information while traversing the subsequent ray through the spatial index. By pre-fetching the bounding volume information, the amount of time to traverse the subsequent ray through the spatial index may be reduced.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### An Exemplary Processor Layout and Communications Network

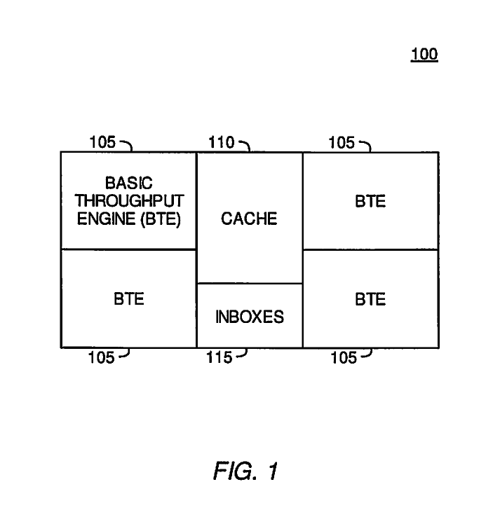

FIG. 1 illustrates a multiple core processing element 100, according to one embodiment of the invention. The multiple core processing element 100 includes a plurality of basic throughput engines 105 (BTEs). A BTE 105 may contain a plurality of processing threads and a core cache (e.g., an L1 cache). The processing threads located within each BTE may have access to a shared multiple core processing element cache 110 (e.g., an L2 cache).

The BTEs 105 may also have access to a plurality of inboxes 115. The inboxes 115 may be memory mapped address space. The inboxes 115 may be mapped to the processing threads located within each of the BTEs 105. Each thread located within the BTEs may have a memory mapped inbox and access to all of the other memory mapped inboxes 115. The inboxes 115 make up a low latency and high bandwidth communications network used by the BTEs 105.

The BTEs may use the inboxes 115 as a network to communicate with each other and redistribute data processing work amongst the BTEs. For some embodiments, separate outboxes may be used in the communications network, for example, to receive the results of processing by BTEs 105. For other embodiments, inboxes 115 may also serve as outboxes, for example, with one BTE 105 writing the results of a processing function directly to the inbox of another BTE 105 that will use the results.

The aggregate performance of an image processing system may be tied to how well the BTEs can partition and redistribute work. The network of inboxes 115 may be used to collect and distribute work to other BTEs without corrupting the shared multiple core processing element cache 110 with BTE communication data packets that have no frame to frame coherency. An image processing system which can render many millions of triangles per frame may include many BTEs 105 connected in this manner.

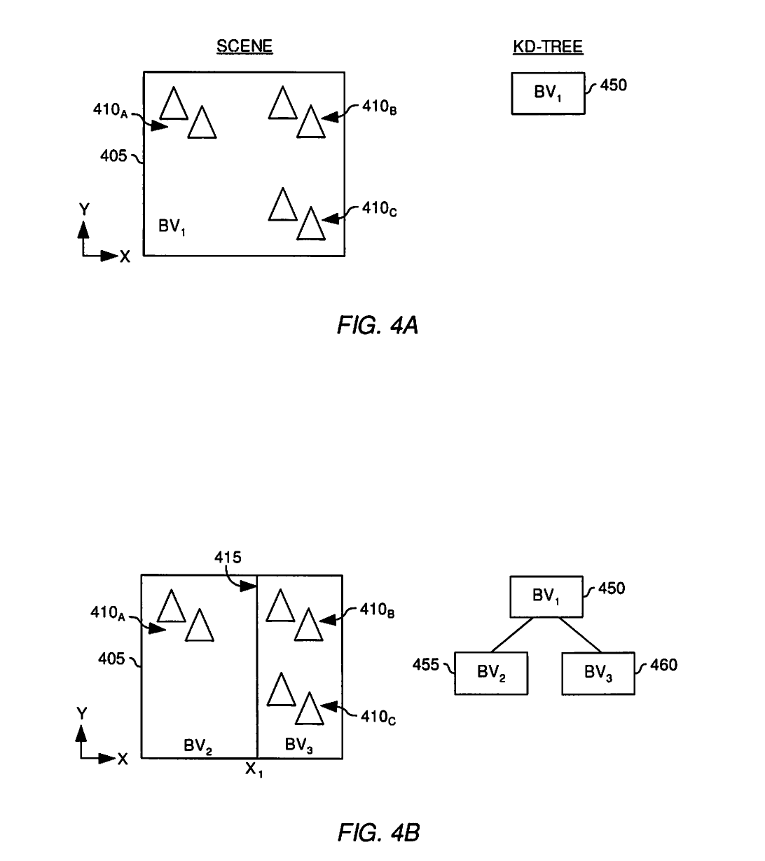

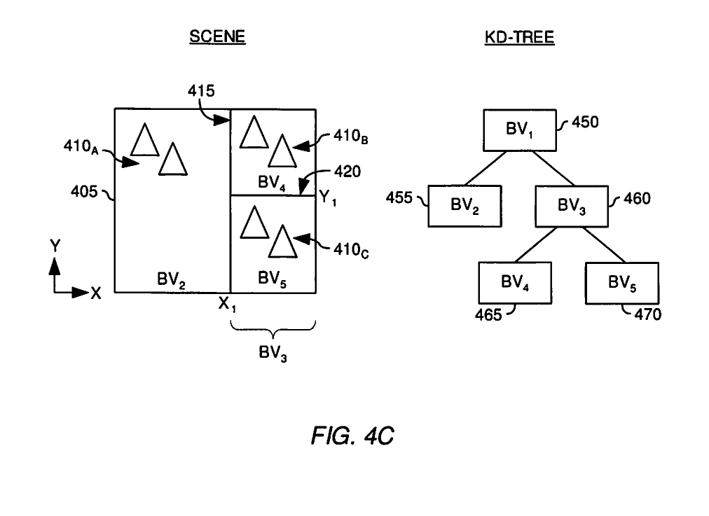

In one embodiment of the invention, the threads of one BTE 105 may be assigned to a workload manager. An image processing system may use various software and hardware components to render a two dimensional image from a three dimensional scene. According to one embodiment of the invention, an image processing system may use a workload manager to traverse a spatial index with a ray issued by the image processing system. A spatial index, as described further below with regards to FIG. 4, may be implemented as a tree type data structure used to partition a relatively large three dimensional scene into smaller bounding volumes. An image processing system using a ray tracing methodology for image processing may use a spatial index to quickly determine ray-bounding volume intersections. In one embodiment of the invention, the workload manager may perform ray-bounding volume intersection tests by using the spatial index.

In one embodiment of the invention, other threads of the multiple core processing element BTEs 105 on the multiple core processing element 100 may be vector throughput engines. After a workload manager determines a ray-bounding volume intersection, the workload manager may issue (send), via the inboxes 115, the ray to one of a plurality of vector throughput engines. The vector throughput engines may then determine if the ray intersects a primitive contained within the bounding volume. The vector throughput engines may also perform operations relating to determining the color of the pixel through which the ray passed.

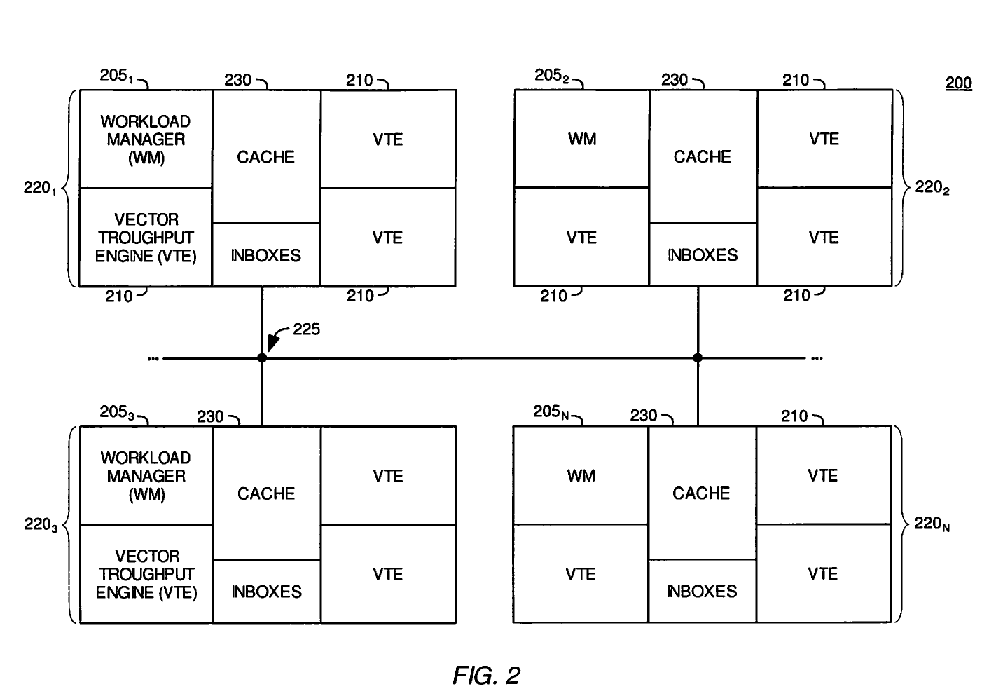

FIG. 2 illustrates a network of multiple core processing elements 200, according to one embodiment of the invention. FIG. 2 also illustrates one embodiment of the invention where the threads of one of the BTEs of the multiple core processing element 100 is a workload manager 205. Each multiple core processing element 220_{1-N} in the network of multiple core processing elements 200 may contain one workload manager 205_{1-N}, according to one embodiment of the invention. Each multiple core processing element 220_{1-N} in the network of multiple core processing elements 200 may also contain a plurality of vector throughput engines 210, according to one embodiment of the invention.

The workload managers 205_{1-N} may use a high speed bus 225 to communicate with other workload managers 205_{1-N} and/or vector throughput engines 210 of other multiple core processing elements 220_{1-N}, according to one embodiment of the invention. Each of the vector throughput engines 210 may use the high speed bus 225 to communicate with other vector throughput engines 210 or the workload managers 205_{1-N}. The workload manager processors 205 may use the high speed bus 225 to collect and distribute image processing related tasks to other workload managers 205_{1-N}, and/or distribute tasks to other vector throughput engines 210. The use of a high speed bus 225 may allow the workload managers 205_{1-N} to communicate without affecting the caches 230 with data packets related to workload manager communications.

### An Exemplary Three Dimensional Scene

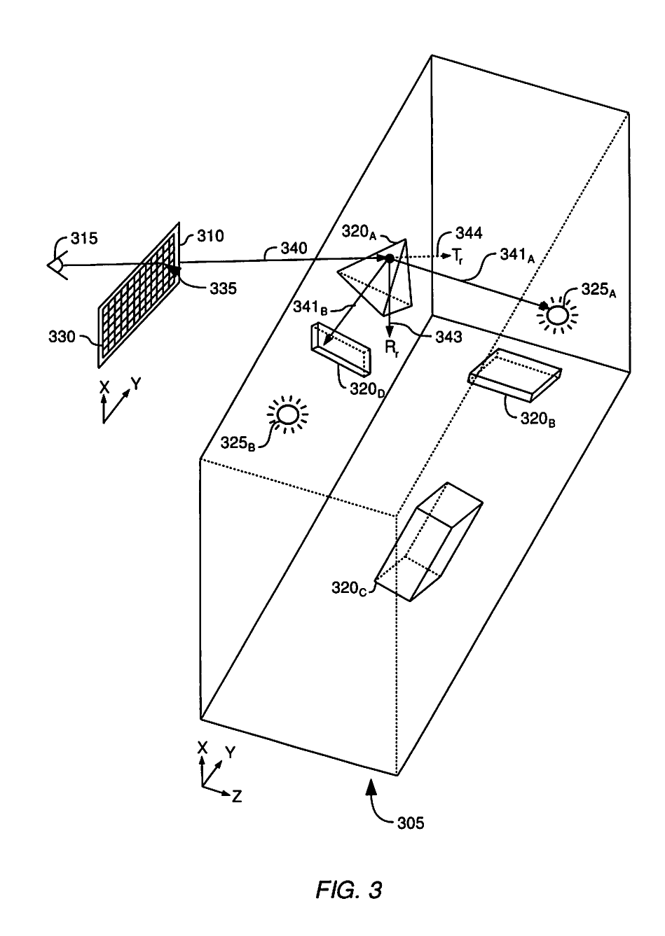

FIG. 3 is an exemplary three dimensional scene 305 to be rendered by an image processing system. Within the three dimensional scene 305 may be objects 320. The objects 320 in FIG. 3 are of different geometric shapes. Although only four objects 320 are illustrated in FIG. 3, the number of objects in a typical three dimensional scene may be more or less. Commonly, three dimensional scenes will have many more objects than illustrated in FIG. 3.

As can be seen in FIG. 3 the objects are of varying geometric shape and size. For example, one object in FIG. 3 is a pyramid 320_{A}. Other objects in FIG. 3 are boxes 320_{B-D}. In many modern image processing systems objects are often broken up into smaller geometric shapes (e.g., squares, circles, triangles, etc.). The larger objects are then represented by a number of the smaller simple geometric shapes. These smaller geometric shapes are often referred to as primitives.

Also illustrated in the scene 305 are light sources 325_{A-B}. The light sources may illuminate the objects 320 located within the scene 305. Furthermore, depending on the location of the light sources 325 and the objects 320 within the scene 305, the light sources may cause shadows to be cast onto objects within the scene 305.

The three dimensional scene 305 may be rendered into a two-dimensional picture by an image processing system. The image processing system may also cause the two-dimensional picture to be displayed on a monitor 310. The monitor 310 may use many pixels 330 of different colors to render the final two-dimensional picture.

One method used by image processing systems to render a three-dimensional scene 320 into a two dimensional picture is called ray tracing. Ray tracing is accomplished by the image processing system “issuing” or “shooting” rays from the perspective of a viewer 315 into the three-dimensional scene 320. The rays have properties and behavior similar to light rays.

One ray 340, that originates at the position of the viewer 315 and traverses through the three-dimensional scene 305, can be seen in FIG. 3. As the ray 340 traverses from the viewer 315 to the three-dimensional scene 305, the ray 340 passes through a plane where the final two-dimensional picture will be rendered by the image processing system. In FIG. 3 this plane is represented by the monitor 310. The point the ray 340 passes through the plane, or monitor 310, is represented by a pixel 335.

As briefly discussed earlier, most image processing systems use a grid 330 of thousands (if not millions) of pixels to render the final scene on the monitor 310. The grid 330 may be referred to as a frame. Each individual pixel may display a different color to render the final composite two-dimensional picture on the monitor 310. An image processing system using a ray tracing image processing methodology to render a two dimensional picture from a three-dimensional scene will calculate the colors that the issued ray or rays encounters in the three dimensional scene. The image processing scene will then assign the colors encountered by the ray to the pixel through which the ray passed on its way from the viewer to the three-dimensional scene.

The number of rays issued per pixel may vary. Some pixels may have many rays issued for a particular scene to be rendered. In which case the final color of the pixel is determined by the each color contribution from all of the rays that were issued for the pixel. Other pixels may only have a single ray issued to determine the resulting color of the pixel in the two-dimensional picture. Some pixels may not have any rays issued by the image processing system, in which case their color may be determined, approximated or assigned by algorithms within the image processing system.

To determine the final color of the pixel 335 in the two dimensional picture, the image processing system must determine if the ray 340 intersects an object within the scene. If the ray does not intersect an object within the scene it may be assigned a default background color (e.g., blue or black, representing the day or night sky). Conversely, as the ray 340 traverses through the three dimensional scene the ray 305 may strike objects. As the rays strike objects within the scene, the color of the object may be assigned to the pixel through which the ray passes. However, the color of the object must be determined before it is assigned to the pixel.

Many factors may contribute to the color of the object struck by the original ray 340. For example, light sources within the three dimensional scene may illuminate the object. Furthermore, physical properties of the object may contribute to the color of the object. For example, if the object is reflective or transparent, other non-light source objects may then contribute to the color of the object.

In order to determine the effects from other objects within the three dimensional scene, secondary rays may be issued from the point where the original ray 340 intersected the object. For example, shadow rays 341 may be issued to determine the contribution of light to the point where the original ray 340 intersected the object. If the object has translucent properties, the image processing system may issue a transmitted or a refracted ray 344 to determine what color or light to be transmitted through the body of the object. If the object has reflective properties, the image processing system may issue a reflected ray to determine what color or light is reflected onto the object 320.

One type of secondary ray may be a shadow ray. Each shadow ray may be traced from the point of intersection of the original ray and the object, to a light source within the three-dimensional scene 305. If the ray reaches the light source without encountering another object before the ray reaches the light source, then the light source will illuminate the object struck by the original ray at the point where the original ray struck the object.

For example, shadow ray 341_{A} may be issued from the point where original ray 340 intersected the object 320_{A}, and may traverse in a direction towards the light source 325_{A}. The shadow ray 341_{A} reaches the light source 325_{A} without encountering any other objects 320 within the scene 305. Therefore, the light source 325_{A} will illuminate the object 320_{A} at the point where the original ray 340 intersected the object 320_{A}.

Other shadow rays may have their path between the point where the original ray struck the object and the light source blocked by another object within the three-dimensional scene. If the object obstructing the path between the point on the object the original ray struck and the light source is opaque, then the light source will not illuminate the object at the point where the original ray struck the object. Thus, the light source may not contribute to the color of the original ray and consequently neither to the color of the pixel to be rendered in the two-dimensional picture. However, if the object is translucent or transparent, then the light source may illuminate the object at the point where the original ray struck the object.

For example, shadow ray 341_{B} may be issued from the point where the original ray 340 intersected with the object 320_{A}, and may traverse in a direction towards the light source 325_{B}. In this example, the path of the shadow ray 341_{B} is blocked by an object 320_{D}. If the object 320_{D} is opaque, then the light source 325_{B} will not illuminate the object 320_{A} at the point where the original ray 340 intersected the object 320_{A}. However, if the object 320_{D} which the shadow ray is translucent or transparent the light source 325_{B} may illuminate the object 320_{A} at the point where the original ray 340 intersected the object 320_{A}.

Another type of secondary ray is a transmitted or refracted ray. A refracted ray may be issued by the image processing system if the object with which the original ray intersected has transparent or translucent properties (e.g., glass). A refracted ray traverses through the object at an angle relative to the angle at which the original ray struck the object. For example, refracted ray 344 is seen traversing through the object 320_{A} which the original ray 340 intersected.

Another type of secondary ray is a transmitted or a refracted ray. If the object with which the original ray intersected has reflective properties (e.g. a metal finish), then a reflected ray will be issued by the image processing system to determine what color or light may be reflected onto the object. Reflected rays traverse away from the object at an angle relative to the angle at which the original ray intersected the object. For example, reflected ray 343 may be issued by the image processing system to determine what color or light may be reflected onto the object 320_{A} which the original ray 340 intersected.

The total contribution of color and light of all secondary rays (e.g., shadow rays, transmitted rays, reflected rays, etc.) will result in the final color of the pixel through which the original ray passed.

### An Exemplary Kd-Tree

One problem encountered when performing ray tracing is determining quickly and efficiently if an issued ray intersects any objects within the scene to be rendered. One methodology known by those of ordinary skill in the art to make the ray intersection determination more efficient is to use a spatial index. A spatial index divides a three-dimensional scene or world into smaller volumes (smaller relative to the entire three-dimensional scene) which may or may not contain primitives. An image processing system can then use the known boundaries of these smaller volumes to determine if a ray may intersect primitives contained within the smaller volumes. If a ray does intersect a volume containing primitives, then a ray intersection test can be run using the trajectory of the ray against the known location and dimensions of the primitives contained within that volume. If a ray does not intersect a particular volume, then there is no need to run ray-primitive intersection tests against the primitives contained within that volume. Furthermore, if a ray intersects a bounding volume which does not contain primitives then there is no need to run ray-primitive intersections tests against that bounding volume. Thus, by reducing the number of ray-primitive intersection tests which may be necessary, the use of a spatial index greatly increases the performance of a ray tracing image processing system. Some examples of different spatial index acceleration data structures are octrees, k dimensional Trees (kd-Trees), and binary space partitioning trees (BSP trees). While several different spatial index structures exist, for ease of describing embodiments of the present invention, a kd-Tree will be used in the examples to follow. However, those skilled in the art will readily recognize that embodiments of the invention may be applied to any of the different types of spatial indexes.

A kd-Tree uses axis aligned bounding volumes to partition the entire scene or space into smaller volumes. That is, the kd-Tree may divide a three dimensional space encompassed by a scene through the use of splitting planes which are parallel to known axes. The splitting planes partition a larger space into smaller bounding volumes. Together the smaller bounding volumes make up the entire space in the scene. The determination to partition (divide) a larger bounding volume into two smaller bounding volumes may be made by the image processing system through the use of a kd-tree construction algorithm.

One criterion for determining when to partition a bounding volume into smaller volumes may be the number of primitives contained within the bounding volume. That is, as long as a bounding volume contains more primitives than a predetermined threshold, the tree construction algorithm may continue to divide volumes by drawing more splitting planes. Another criterion for determining when to partition a bounding volume into smaller volumes may be the amount of space contained within the bounding volume. Furthermore, a decision to continue partitioning the bounding volume may also be based on how many primitives may be intersected by the plane which creates the bounding volume.

The partitioning of the scene may be represented by a binary tree structure made up of nodes, branches and leaves. Each internal node within the tree may represent a relatively large bounding volume, while the node may contain branches to sub-nodes which may represent two relatively smaller partitioned volumes resulting after a partitioning of the relatively large bounding volume by a splitting plane. In an axis-aligned kd-Tree, each internal node may contain only two branches to other nodes. The internal node may contain branches (i.e., pointers) to one or two leaf nodes. A leaf node is a node which is not further sub-divided into smaller volumes and contains pointers to primitives. An internal node may also contain branches to other internal nodes which are further sub-divided. An internal node may also contain the information needed to determine along what axis the splitting plane was drawn and where along the axis the splitting plane was drawn.

### Exemplary Bounding Volumes

FIGS. 4A-4C illustrate a two dimensional space to be rendered by an image processing system and a corresponding kd-tree. For simplicity, a two dimensional scene is used to illustrate the building of a kd-Tree, however kd-Trees may also be used to represent three dimensional scenes. In the two dimensional illustration of FIGS. 4A-4C splitting lines are illustrated instead of splitting planes, and bounding areas are illustrated instead of bounding volumes as would be used in a three dimensional structure. However, one skilled in the art will quickly recognize that the concepts may easily be applied to a three dimensional scene containing objects.

FIG. 4A illustrates a two dimensional scene 405 containing primitives 410 to be rendered in the final picture to be displayed on a monitor 310. The largest volume which represents the entire volume of the scene is encompassed by bounding volume 1 (BV₁). In the corresponding kd-Tree this may be represented by the top level node 450, also known as the root or world node. In one embodiment of an image processing system, an image processing system may continue to partition bounding volumes into smaller bounding volumes when the bounding volume contains, for example, more than two primitives. As noted earlier the decision to continue partitioning a bounding volume into smaller bounding volumes may be based on many factors, however for ease of explanation in this example the decision to continue partitioning a bounding volume is based only on the number of primitives. As can be seen in FIG. 4A, BV₁ contains six primitives, therefore kd-Tree construction algorithm may partition BV₁ into smaller bounding volumes.

FIG. 4B illustrates the same two dimensional scene 405 as illustrated in FIG. 4A. However, in FIG. 4B the tree construction algorithm has partitioned BV₁ into two smaller bounding volumes BV₂ and BV₃. The partitioning of BV₁, was accomplished, by drawing a splitting plane SP₁ 415 along the x-axis at point x₁. This partitioning of BV₁ is also reflected in the kd-Tree as the two nodes 455 and 460, corresponding to BV₂ and BV₃ respectively, under the internal or parent node BV₁ 450. The internal node representing BV₁ may now store information such as, but not limited to, pointers to the two nodes beneath BV₁ (e.g., BV₂ and BV₃), along which axis the splitting plane was drawn (e.g., x-axis), and where along the axis the splitting plane was drawn (e.g., at point x₁).

The kd-Tree construction algorithm may continue to partition bounding volume BV₃ because it contains more than the predetermined threshold of primitives (e.g., more than two primitives). However, the kd-Tree construction algorithm may not continue to partition bounding volume BV₂, because bounding volume BV₂ contains less than or equal to the number of primitives (e.g., only two primitives 410_{A}). Nodes which are not partitioned or sub-divided any further, such as BV₂, are referred to as leaf nodes.

FIG. 4C illustrates the same two dimensional scene 405 as illustrated in FIG. 4B. However, in FIG. 4C the kd-Tree construction algorithm has partitioned BV₃ into two smaller bounding volumes BV₄ and BV₅. The kd-construction algorithm has partitioned BV₃ using a partitioning plane along the y-axis at point y₁. Since BV₃ has been partitioned into two sub-nodes it may now be referred to as an internal node. The partitioning of BV₃ is also reflected in the kd-Tree as the two leaf nodes 465 and 470, corresponding to BV₄ and BV₅ respectively. BV₄ and BV₅ are leaf nodes because the volumes they represent are not further divided into smaller bounding volumes. The two leaf nodes, BV₄ and BV₅, are located under the internal node BV₃ which represents the bounding volume which was partitioned in the kd-Tree.

The internal node representing BV₃ may store information such as, but not limited to, pointers to the two leaf nodes (i.e., BV₄ and BV₅), along which axis the splitting plane was drawn (i.e., y-axis), and where along the axis the splitting plane was drawn (i.e., at point y₁).

The kd-Tree construction algorithm may now stop partitioning the bounding volumes because all bounding volumes located within the scene contain less than or equal to the maximum predetermined number of primitives which may be enclosed within a bounding volume. The leaf nodes may contain pointers to the primitives which are enclosed within the bounding volumes each leaf represents. For example, leaf node BV₂ may contain pointers to primitives 410_{A}, leaf node BV₄ may contain pointers to primitives 410_{B}, and leaf node BV₅ may contain pointers to primitives 410_{C}.

A ray tracing image processing system may use the workload manager 205 to traverse the spatial index (kd-Tree). Traversing the kd-Tree may include selecting a branch to a node on a lower level (sub-node) of the kd-Tree to take or proceed to in order to determine if the ray intersects any primitives contained within the sub-node. A workload manager 205 may use the coordinates and trajectory of an issued ray to traverse or navigate through the kd-Tree. By executing ray-bounding volume intersection tests, the workload manager 205 may determine if the ray intersects a plane of the bounding volumes represented by nodes within the kd-Tree structure. If the ray intersects a bounding volume which contains only primitives (i.e., a leaf node), then the workload manager 205 may send the ray and associated information to a vector throughput engine 210 for ray-primitive intersection tests. A ray-primitive intersection test may be executed to determine if the ray intersects the primitives within the bounding volume. This methodology results in fewer ray-primitive intersection tests needed to determine if a ray intersects an object within the scene, in comparison to running ray-primitive intersection tests for a ray against each primitive contained within the scene.

The resulting kd-Tree structure, or other spatial index structure, may be stored in a processor cache 230. The kd-Tree and the size of corresponding data which comprises the kd-Tree may be optimized for storage in a processor cache 230. The storage of the kd-Tree in a processor cache 230 may allow a workload manager 205 to traverse the kd-Tree with a ray that has been issued by the image processing system without having to retrieve the kd-Tree from memory every time a ray is issued by the image processing system.

### Pattern for Issuing Rays into a Three Dimensional Scene

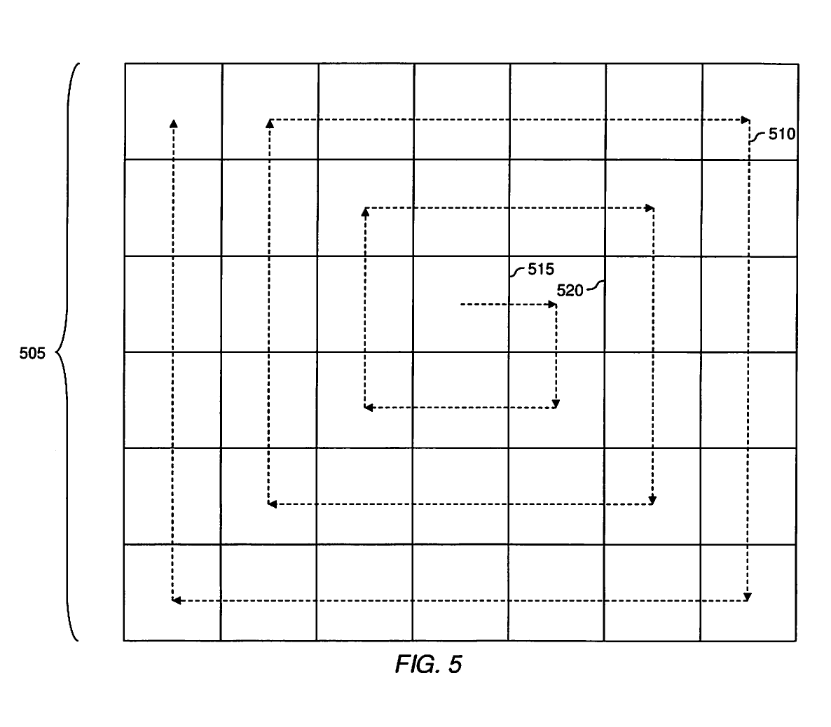

According to embodiments of the invention, an image processing system may follow a pattern when issuing rays into a three dimensional scene. FIG. 5 illustrates an exemplary pattern 510 which an image processing system may follow to issue rays into a three dimensional scene (e.g., the three dimensional scene 305 of FIG. 3), according to one embodiment of the invention. FIG. 5 illustrates a grid of pixels 505 which may make up a portion of a much larger monitor 310. The exemplary pattern 510 which an image processing system may follow in issuing rays into a portion of a three dimensional scene 305 is illustrated by the dashed arrow lines flowing throughout the grid of pixels 505. The image processing system may issue the first ray into the three dimensional scene 305 through the center most pixel 515. Next, the image processing system following the pattern 510 in FIG. 5 may issue a second ray through the pixel immediately to the right of the center-most pixel (i.e., pixel 520). The image processing system may continue to issue one ray per pixel along the dashed line representing the pattern 510 until the image processing system has issued one ray per pixel for every pixel in the monitor 310. Moreover, according to other embodiments of the invention the image processing system may issue a different number of rays per pixel, or may follow a different pattern.

Due to the pattern, over a period of time rays may be issued into the scene with relatively similar trajectories which may cause the rays to follow a relatively similar path. Rays which follow a similar path often end up traversing through the three dimensional scene relatively close to each other as well. Consequently, the rays issued relatively close to each other in the pattern may be traversed through the spatial index taking relatively the same branches to nodes which define bounding volumes within the three dimensional scene which were intersected by the rays.

Since it is likely that subsequently issued rays will intersect the same bounding volumes, the image processing system may record the traversal path of a previously issued ray (or rays) through the spatial index and use the recorded traversal path to pre-fetch information defining the bounding volumes intersected by the previous ray when traversing the spatial index with a subsequent ray. In contrast to fetching bounding volume information as the workload manager traverses a subsequent ray through the spatial index, by pre-fetching the bounding information the overall amount of time necessary to traverse a subsequent ray through the spatial index may be reduced.

### Recording Spatial Index Branch History

In order to pre-fetch the bounding volumes for use in calculations relating to tracing a subsequently issued ray through the spatial index, the image processing system may record the traversal of a previously issued ray through the spatial index. According to one embodiment of the invention, the image processing system may record the traversal history of a previous ray by recording the branches taken to/from nodes in the spatial index. The image processing system may use a branch history table to record the branches taken while traversing a ray through the spatial index.

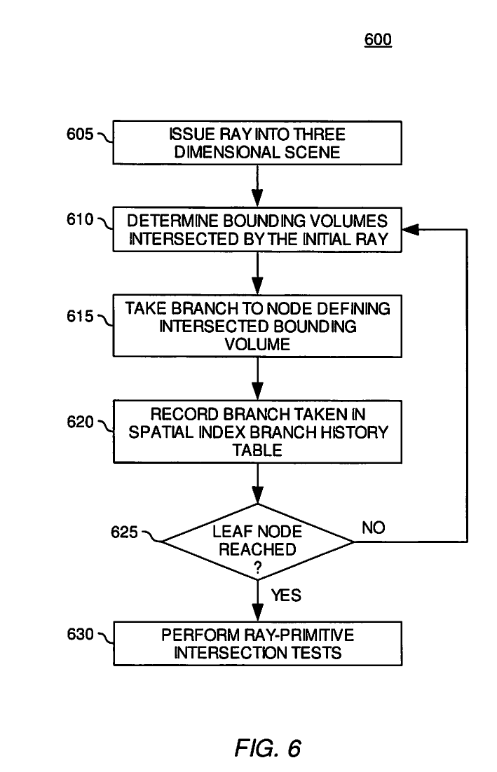

FIG. 6 is a flowchart illustrating a method 600 of traversing a spatial index with a ray and recording a branch history while traversing the spatial index, according to one embodiment of the invention. The method 600 begins at step 605 when the image processing system (e.g., through the use of a workload manager 205) may issue an initial ray into a three dimensional scene. For example, if the image processing system is following the pattern 510 illustrated in FIG. 5, the image processing system may issue the initial ray through the center-most pixel 515. After the ray traverses through the center most pixel 515 it may traverse into the three dimensional scene which is represented by a spatial index.

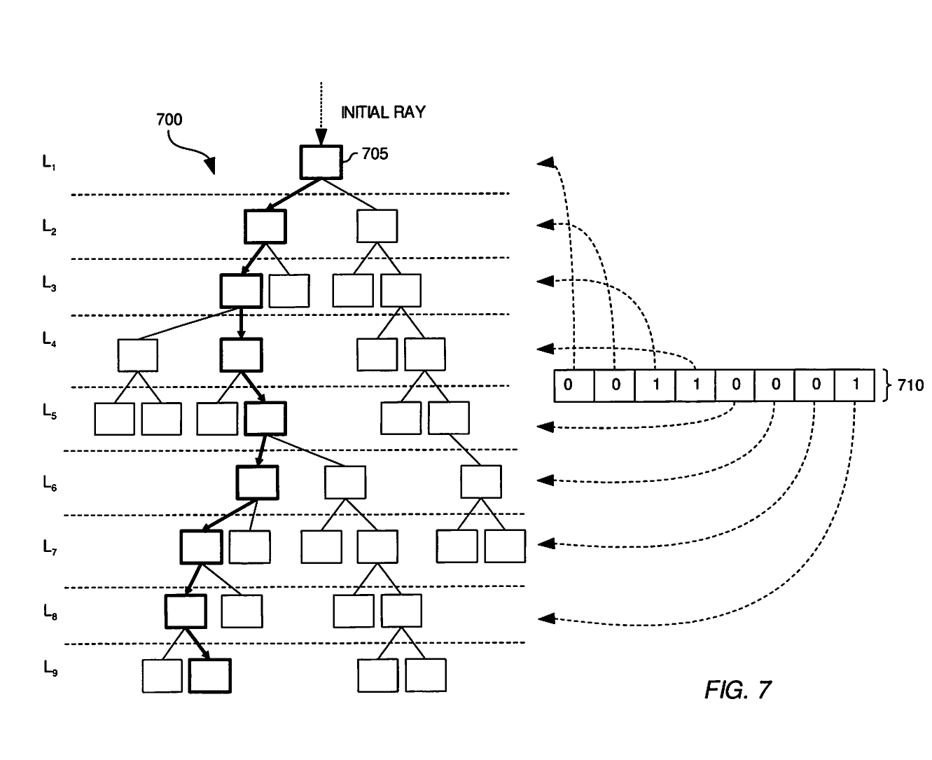

For example, FIG. 7 illustrates a spatial index 700 corresponding to a three dimensional scene. The spatial index 700 has a world node 705 and contains nine node levels (i.e., L₁-L₉). Each node level contains nodes which define bounding volumes within the three dimensional scene.

After issuing the initial ray into the three dimensional scene, at step 610, the workload manager may perform ray-bounding volume intersection tests to determine the nodes on the node level directly beneath the world node 705 that are intersected by the initial ray.

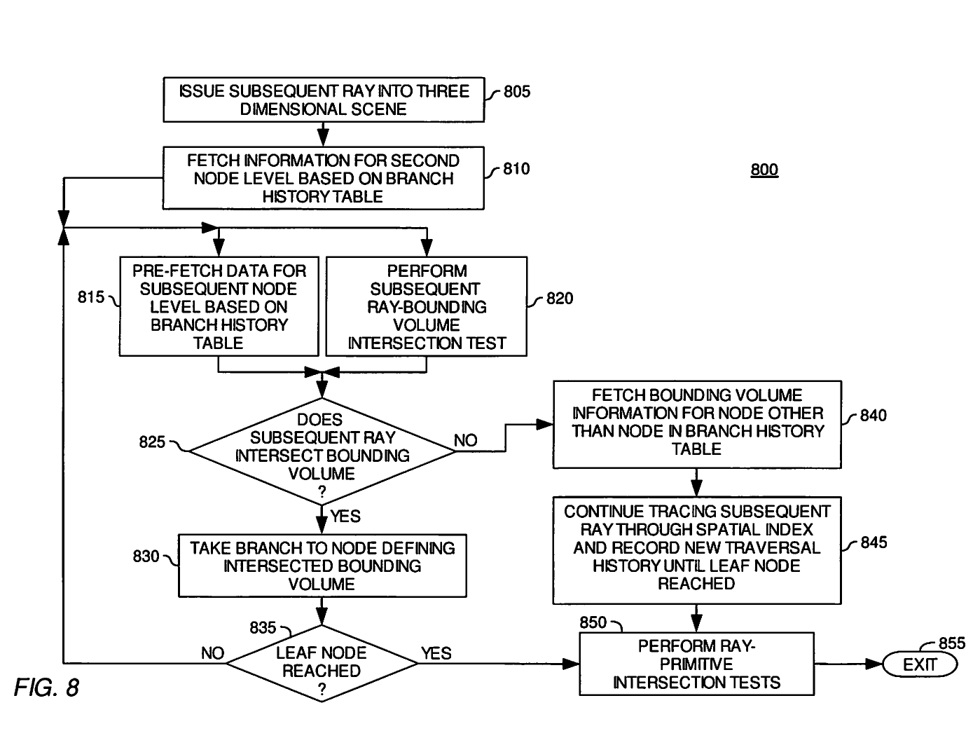

In order to perform ray-bounding volume intersection tests, a workload manager 205 may fetch the information which defines the bounding volumes from memory and load the information into local data registers within the workload manager 205. Loading the information which defines the bounding volumes may take several processor cycles. During these processing cycles the workload manager 205 may have to wait for the information to be fetched from memory and placed into the data registers. Thus, the workload manager 205 may be idle while the data is being fetched form memory. As described below with regards to FIG. 8, according to embodiments of the invention, when traversing subsequently issued rays through a spatial index 700, bounding volume information may be pre-fetched based on a branch history table to avoid idle processor cycles.

After the information defining the bounding volume is loaded into the data registers of the workload manager 205, the workload manager 205 may perform the ray-bounding volume intersection tests to determine which bounding volume is intersected by the ray. Next, at step 615, the workload manager 205 may take the branch to the node defining the bounding volume intersected by the ray. For example, as illustrated in FIG. 7, based on the results of the ray-bounding volume tests, the workload manager 205 may determine that the initial ray intersects the bounding volume defined by the node to the left and below the world node 705. Therefore, the workload manager 205 may take the left branch to reach the node which defines the bounding volume intersected by the initial ray.

Next, at step 620 the workload manager 205 may record the branch taken by the workload manager 205 in a branch history table. According to one embodiment of the invention, as illustrated in FIG. 7, the branch history table 710 may contain a series of bits. Each bit location within the branch history table 710 may correspond to a level (e.g., L₁-L₉) of the spatial index 700. Furthermore, each bit location may contain either an asserted bit (i.e., logical ‘1’) or an unasserted bit (i.e., logical ‘0’). According to embodiments of the invention, a ‘0’ for the bit location may indicate that a left branch was taken from the node on the level to which the bit location corresponds, and a ‘1’ for the bit location may indication that a right branch was taken from the node on the level to which the bit location corresponds. For example, the first bit in the branch history table 710 may correspond to the first node level within the spatial index 700 (e.g., L₁). As described above, the workload manager 205 may determine that the initial ray intersects the bounding volume defined by the node below and to the left of the world node 705. Therefore, at step 620, the workload manager 205 may set the bit in the corresponding location in the branch history table 710 to ‘0’. Setting the bit to ‘0’ indicates that the left branch was taken from the first node level L₁ in the spatial index 700.

After step 620 the workload manager 205 may proceed to step 625, where the workload manager 205 may determine if the initial ray has been traversed to a leaf node of the spatial index 700. If not, the workload manager 205 may return to step 610 to continue traversing the spatial index 700 until a leaf node is reached. Thus, until a leaf node is reached, the workload manager 205 may continue to perform ray-bounding volume intersection tests (step 610), take branches to nodes defining bounding volumes intersected by the initial ray (step 615), and record the branches taken in a branch history table 710 (step 620).

FIG. 7, illustrates one exemplary path that the initial ray may have traversed through the spatial index 700. The traversal path of the initial ray through the spatial index 700 is illustrated in FIG. 7 by the darkened arrows indicating the branches taken by the workload manager 205, and by darkened boxes indicating the nodes which define bounding volumes intersected by the initial ray. Furthermore, the branch history table 710 is illustrated in FIG. 7 with the branch history bits populated corresponding to the branches taken by the workload manager 205 as the initial ray was traversed through the spatial index 700. As illustrated, the branch history table 710 has a single bit corresponding to each level (i.e., L₁₋₉) of the spatial index 700 from which a branch was taken. Thus, the branch history table 710 contains a recording of the branches taken by the workload manager 205 as it traversed the initial ray through the spatial index 700.

After the workload manger 205 has traversed the initial ray through the spatial index 700 until a leaf node was reached, the workload manager may proceed to step 630 where ray-primitive intersection tests may be performed to determine if the initial ray intersects any primitives contained within the bounding volume defined by the leaf node. According to one embodiment of the invention, the workload manager 205 may perform the ray-primitive intersections tests, or according to another embodiment of the invention the ray-primitive intersection tests may be performed by a vector throughput engine 210.

### Pre-Fetching Bounding Volume Data Based on a Spatial Index Branch History Table and Updating a Spatial Index Branch History Table

After an initial ray has been traced through the spatial index 700, the workload manager 205 may issue a subsequent ray into the three dimensional scene. The subsequent ray may be issued such that it traverses through a pixel 520 adjacent to the center most pixel 515. Consequently, since the subsequently issued ray may have a trajectory similar to the previously issued or initial ray, it is likely that the subsequently issued ray will traverse through the three dimensional scene with a similar path as the initial ray. Furthermore, it is likely that the subsequently issued ray, having a trajectory similar to the previous ray, will intersect the same bounding volumes in the spatial index as were intersected by the initial ray.

As described above in method 600, the branches taken by the workload manager 205 while traversing the initial ray through the spatial index 700 may have been recorded. The branches taken to nodes defining the bounding volumes intersected by the initial ray may have been recorded in the branch history table 710, and thus the branch history table 710 may be used to pre-fetch the information defining the bounding volumes which are likely to be intersected by the subsequent ray. The pre-fetched information may be placed in the local data registers of the workload manager 205 before the workload manager 205 needs to execute the subsequent ray-bounding volume tests. Thus, when the workload manager 205 needs to execute the ray-bounding volume tests, the information may be present in the data registers without the workload manager 205 needing to fetch the bounding volume information once the workload manager 205 starts to execute subsequent ray-bounding volume tests. Consequently, if the bounding volume which was pre-fetched by the workload manager 205 prior to the need to perform subsequent ray-bounding volume intersection tests is the correct bounding volume (i.e., the subsequently issued ray intersected the pre-fetched bounding volume), the processor cycles which may have been necessary to fetch the data are no longer required. Therefore, the amount of time necessary to trace a ray through a spatial index and consequently the time necessary to render a two dimensional image from a three dimensional scene may be reduced by the number of processor cycles required to fetch bounding volume information.

However, if the workload manager 205 determines that the pre-fetched data is not the correct data (i.e., the subsequently issued ray does not intersect the pre-fetched bounding volume), the appropriate bounding volume information may be fetched from memory and the branch history table updated such that future use of the branch history table is more likely to be accurate for subsequently issued rays. Due to the fact that the image processing system issues rays in a pattern, and over periods of time subsequently issued rays have similar trajectories due to the pattern, it is more likely that subsequently issued rays will intersect the same bounding volumes as previously issued rays (e.g., the initial ray). Thus, the benefits gained by pre-fetching bounding volume information (time necessary to traverse a ray through the spatial index reduced) are more likely to outweigh the costs of pre-fetching bounding volume information (performing subsequently issued ray-bounding volume intersection tests with pre-fetched bounding volumes which are not intersected by the ray).

FIG. 8 is a flowchart illustrating a method 800 of pre-fetching bounding volume data based on a branch history table 710 and updating a branch history table 710, according to one embodiment of the invention. The method 800 begins at step 805 when the image processing system (e.g., through the use of a workload manager 205) may issue a subsequent ray (e.g., immediately following the initial ray) into the three dimensional scene and commence traversing the subsequent ray through the spatial index 700.

Next, at step 810 the workload manager 205 may fetch from memory the information which defines a bounding volume corresponding to the second node level L₂. The bounding volume information which is fetched may be determined by checking the branch history table 710. The branch history table 710 may indicate the branch taken from the first node level L₁ which leads to the node on the second level. From this information, the node which was branched to may be determined and the bounding volume information corresponding to the branched to node fetched from memory.

By checking the branch history table 710, the workload manager 205 may determine that the previous ray (e.g., the initial ray) took a branch to the left and below the world node level to get to the node on the second node level L₂. Thus, at step 810 the workload manager 205 may fetch information which defines the bounding volume corresponding to the node below and to the left of the world node 705 of the spatial index 700 illustrated in FIG. 7. The workload manager 205 may then place the fetched information into local data registers within the workload manager 205.

Fetching the bounding volume information from memory may take a significant amount of time relative to the time necessary to perform the ray-bounding volume intersection tests. Fetching bounding volume information from memory may require reading data from a memory location in the cache memory or in system memory and loading the data read from memory into a register within the workload manager 205. While the data is being fetched from memory the processor may not have other processes needing execution and thus may sit idle.

After fetching the information defining the bounding volume corresponding to first node level, the workload manager 205 may proceed simultaneously to two different steps. The two steps may be the beginning of a loop containing steps 815, 820, 825, 830, and 835 which, as explained further below, may iterate as many times as the subsequent ray traverses to the same node as was traversed to by the previous ray (e.g., the initial ray).

The workload manager 205, having a plurality of processing threads, may execute instructions simultaneously. Therefore, the two initial steps of the loop (i.e., step 815 and step 820) may be performed simultaneously by separate processing threads and/or circuitry within the workload manager 205.

At step 815, the workload manager 205 may pre-fetch data for a subsequent node level based on the branch history table 710. The first time the workload manager proceeds to step 815 the subsequent node level may be, for example, the third node level L₃, because the information defining the bounding volume for the second node level L₂ may have been previously fetched from memory and placed in the data registers of the workload manager 205 during step 810. What data is pre-fetched for the subsequent node level in step 815 may be determined based on the branch history table 710.

For example, as described in FIG. 7 the branch history table 710 indicates that the previously issued ray intersected the node on the third level L₂, to the left and below the node on the second node level L₃. The branch history table indicates this node because the branch history table 710 has a ‘0’ in the bit location of the branch history table 710 corresponding to the second node level L₂, as illustrated in the branch history table 710. Thus, in step 815 the workload manager 205 may pre-fetch the information which defines the bounding volume corresponding to the node to the left and below the node on the second node level L₂. The workload manager 205 may place the pre-fetched information in the data registers of the workload manager 205.

Simultaneously during the execution of step 815, the workload manager 205 may execute step 820. At step 820, the workload manager 205 may perform ray-bounding volume intersection tests for the subsequently issued ray. The workload manager 205 may perform the ray-bounding volume intersection tests using bounding volume information which was loaded into data registers within the workload manager 205.

The bounding volume information used in step 820 may have been loaded into the data registers of the workload manager 205 in one of two different steps. During the first execution of step 820 for a subsequently issued ray, the information defining the node on the second node level L₂ may have been fetched from memory and loaded into the registers of the workload manager during step 810. However, for later passes through step 820, bounding volume information defined by nodes on node levels lower than the second node level may be pre-fetched and loaded into the data registers.

By pre-fetching bounding volume information during step 815 as the workload manager 205 is executing ray-bounding volume intersection tests for bounding volumes defined by nodes on previous or higher levels of the spatial index, the workload manager 205 may eliminate the idle time associated with waiting for bounding volume information to be fetched from memory.

After steps 815 and 820 the workload manager 205 may proceed to step 825, where the workload manager 205 may determine if the subsequently issued ray intersects the bounding volume it was tested against in step 820. If so, the workload manager 205 may proceed to step 830, where the workload manager 205 may take the branch in the spatial index to the node which defines the bounding volume intersected by the subsequently issued ray.

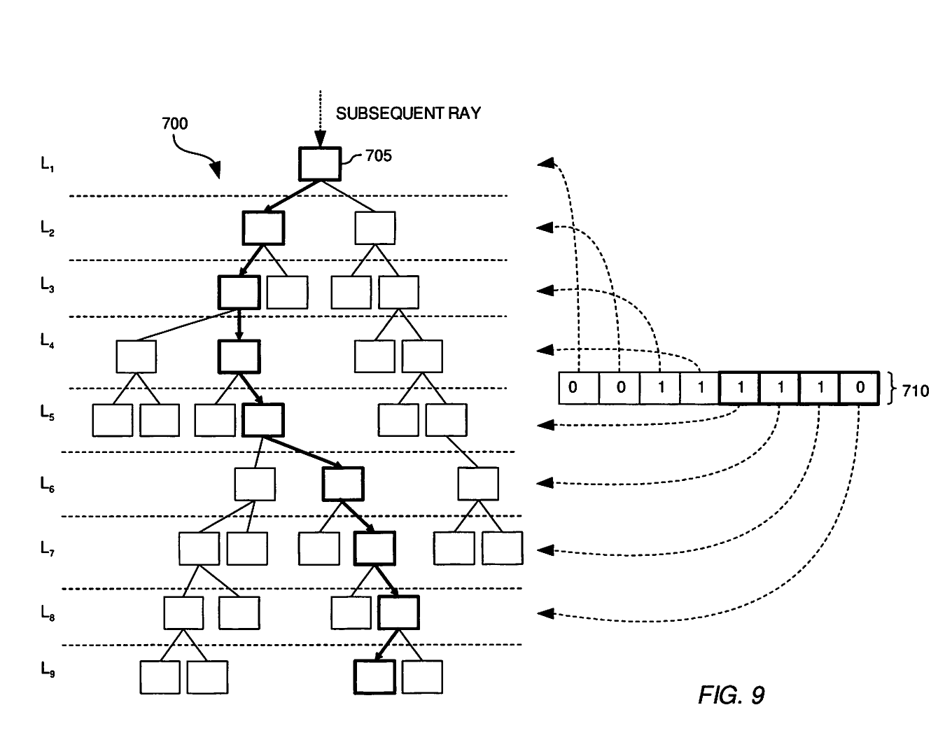

For example, FIG. 9 illustrates the traversal path of a subsequently issued ray through the spatial index 700, according to one embodiment of the invention. As illustrated, the subsequently issued ray does intersect the bounding volume defined by node on the second node level L₂ to the left of the world node 705. Thus, at step 830 the workload manager 205 may take the branch to the node on the second node level L₁ (i.e., the node to the left and below the world node) which defines the intersected bounding volume.

If however, at step 825, the workload manager 205 determines that the subsequently issued ray does not intersect the bounding volume it was tested against in step 820, the workload manager 205 may proceed to step 845 where the workload manager 205 may perform a series of steps (840, 845, and 850) relating to traversing the subsequent ray through the spatial index without pre-fetching bounding volumes based on the branch history table 710. The series of steps are discussed further below.

However if the ray did intersect the pre-fetched bounding volume and the workload manager 205 took the branch in the spatial index to the node defining the intersected bounding volume in step 830, at step 835 the workload manager 205 may determine if the subsequent ray has been traversed to a leaf node. If so, the workload manager 205 may proceed to step 850 where the workload manager or other processing element (e.g., a vector throughput engine 210) may perform ray-primitive intersection tests to determine if the subsequently issued ray intersects any primitives contained within the bounding volume defined by the leaf node. However, if at step 835 the workload manager 205 determines that the subsequently issued ray has not been traversed to a leaf node, the workload manager 205 may return to simultaneously executing steps 815 and 820.

Thus, if a subsequently issued ray continues to intersect the bounding volumes which were intersected by the previously issued ray and a leaf node has not been reached, the workload manager 205 may continue to return to steps 815 and 820 to pre-fetch data relating to bounding volumes for subsequent node levels based on the branch history table and continue to perform subsequent ray-bounding volume intersection tests with the data that was pre-fetched during a previous execution of step 815.

For example, with respect to the subsequently issued ray whose spatial index traversal is illustrated in FIG. 9, the workload manager 205 may pre-fetch bounding volume information according to the branch history table (i.e., execute step 815) five times. A workload manager 205 traversing the subsequently issued ray whose traversal path is illustrated in FIG. 9 may pre-fetch data (i.e., execute step 815) once for the third node level L₃, once for the fourth node level L₄, once for the fifth node level L₅, once for the sixth node level L₆, and once for the seventh node level L₇.

However, after simultaneously pre-fetching the bounding volume information for the seventh node level L₇ and performing subsequent ray-bounding volume intersection tests at step 820 against the bounding volume on the sixth node level L₆, the image processing system may determine at step 825 that the subsequent ray does not intersect the pre-fetched bounding volume on the sixth node level L₆. Thus, the subsequent ray's trajectory differed enough from the trajectory of the previous ray (e.g., the initial ray) such that the subsequent ray did not intersect the pre-fetched bounding volume. Because it is determined at step 825 that the subsequently issued ray does not intersect the pre-fetched bounding volume, at step 825, the workload manager 205 may proceed to step 840.

At step 840, the workload manager 205 may fetch the bounding volume information for a node other than the node for which the bounding volume information was pre-fetched. For example, if the image processing system uses a kd-tree as a spatial index, then each internal node only branches to two nodes. Therefore, at step 840 the workload manager 205 may fetch the bounding volume information to the right and below the parent node if the workload manager 205 had pre-fetched the bounding volume information to the left and below the parent node. Conversely, the workload manager 205 may fetch the bounding volume to the left and below the parent node if the workload manager had pre-fetched the bounding volume information to the right and below the parent node.

Therefore, as illustrated in FIG. 9, at step 820 the workload manager 205 may have pre-fetched the bounding volume for the node to the left and below the node on the fifth node level L₅ according to the fifth bit in the branch history table 710 (i.e., a ‘0’ indicating the previous ray took the branch to the left and below the node on the fifth node level L₅). However, in step 825 the workload manager 205 may determine that the subsequently issued ray did not intersect the node to the left and below the node on the fifth node level L₅. Therefore, in step 840 the workload manager 205 may fetch the bounding volume information for a node other than the node which was pre-fetched in step 815 as per the branch history table 710.

For example, as illustrated in FIG. 9, at step 840 the workload manager 205 may fetch the bounding volume information defined by the node below and to the right of the node on the fifth node level L₅ of the spatial index 700. Next, at step 845, the workload manager 205 may continue tracing the subsequent ray through the spatial index and record a new branch history in the branch history table 710. Thus, in step 845 the workload manager 205 may fetch bounding volume information defined by the nodes and take branches to nodes which defined bounding volumes intersected by the subsequent ray. As the workload manager 205 takes branches to nodes, the workload manager 205 may record the branches taken when traversing the spatial index 700 with the subsequent ray in a branch history table. According to one embodiment of the invention, the branch history table may be updated according to the branches taken by the subsequently issued ray.

For example, as illustrated by the bolded bits in the branch history table 710 illustrated in FIG. 9, the branch history table 710 has been updated to represent the last four branches taken by the workload manager 205 as the subsequent ray was traversed through the spatial index. By updating the branch history table with the most recent traversal of the spatial index, the workload manager 205 may pre-fetch bounding volume data corresponding to more recently issued rays which may follow a similar trajectory to the later issued rays

After traversing the subsequently issued ray through the spatial index 700 until a leaf node is reached, the workload manager 205 (or other suitable processing element) may perform ray-primitive intersection tests to determine if the subsequently issued ray intersects any primitives located within the bounding volume defined by the leaf node.

Recording a spatial index branch history and using a spatial index branch history may be implemented in hardware, software, or both according to embodiments of the invention. For example, according to one embodiment of the invention, a spatial index branch history may be recorded and stored within a register located in a workload manager. Spatial index information (e.g., bounding volumes) may then be pre-fetched by the workload manager based on the branch history stored in the register. Alternatively, according to another embodiment of the invention, a spatial index branch history may be recorded by software, and information identified by the spatial index branch history (e.g., bounding volumes) may be pre-fetched by the software. Furthermore, other embodiments are contemplated which make use of hardware and/or software in order to record and use a spatial index branch history.

### CONCLUSION

According to embodiments of the invention, the branches taken by a previously issued ray may be recorded as the previously issued ray is traversed through a spatial index. The recorded branch history may later be used to pre-fetch information which defines bounding volumes the previously issued ray intersected. The bounding volume information may be fetched while a processing element is performing other image processing related tasks, and may be waiting in the processing element's data registers when the processing element is ready to perform ray-bounding volume intersection tests with a subsequent ray. If the subsequent ray intersects the same bounding volume as the previously issued ray, the amount of time necessary to traverse the spatial index may be reduced by the amount of time necessary to fetch the bounding volume information. By reducing the time necessary to traverse rays through the spatial index, the amount of time necessary to render a two dimensional image from a three dimensional scene may be reduced.

Although the methods and apparatus for recording and using a branch history of a tree structure are herein described with reference to using a spatial index for ray tracing image processing, it should be understood that the invention is not limited to recording and using a branch history for performing ray tracing alone. Instead, embodiments of the invention may be used to record and use a branch history while traversing a tree structure which may representing a variety of items. For example, embodiments of the invention relating to recording and using a branch history may be used in conjunction with tree structures used for physics simulation, audio simulation, or artificial intelligence simulation. Thus, tree traversal in general, whether related to image processing or not, may use the methods and apparatus described herein.

While the foregoing is directed to embodiments of the present invention, other and further embodiments of the invention may be devised without departing from the basic scope thereof, and the scope thereof is determined by the claims that follow.

What is claimed is:

1. A method of ray tracing utilizing a spatial index having nodes defining bounded volumes of a three dimensional scene, comprising:
issuing a first ray into the three dimensional scene;
traversing the spatial index by taking branches from internal nodes until a leaf node is reached, wherein branches are taken based on whether the first ray intersects bounding volumes defined by the nodes;
recording a history of traversal of the first ray;
issuing a second ray into the three dimensional scene;
pre-fetching information defining bounded volumes intersected by the first ray based on the history of traversal of the first ray; and
traversing the spatial index by taking branches from internal nodes until a leaf node is reached, wherein branches are taken based on whether the second ray intersects bounding volumes defined by the nodes.

2. The method of claim 1, wherein recording the history of traversal of the first ray comprises:
populating a branch history table which identifies the branches taken while traversing the spatial index with the first ray.

3. The method of claim 2, wherein the spatial index is a kd-tree, and wherein the branch history table comprises a series of bit locations which correspond to node levels within the kd-tree.

4. The method of claim 3, wherein populating a branch history table comprises:
placing a first value in a bit location which indicates a left branch was taken from a corresponding node level; and
placing a second value in a bit location which indicates a right branch was taken from a corresponding node level.

5. The method of claim 2, further comprising:
recording a history of traversal of the second ray.

6. The method of claim 5, wherein recording a history of traversal of the second ray comprises updating the branch history table to reflect the branches taken while traversing the spatial index with the second ray.

7. The method of claim 1, wherein pre-fetching information defining bounding volumes comprises retrieving the information from memory and placing the information into local data registers of a processing element.

8. A computer readable medium containing a program which, when executed, performs an operation, comprising:
issuing an first ray into the three dimensional scene;
traversing the spatial index by taking branches from internal nodes until a leaf node is reached, wherein branches are taken based on whether the first ray intersects bounding volumes defined by the nodes;
recording a history of traversal of the first ray;
issuing a second ray into the three dimensional scene;
pre-fetching information defining bounded volumes intersected by the first ray based on the history of traversal of the first ray; and
traversing the spatial index by taking branches from internal nodes until a leaf node is reached, wherein branches are taken based on whether the second ray intersects bounding volumes defined by the nodes.

9. The computer readable medium of claim 8, wherein recording the history of traversal of the first ray comprises:
populating a branch history table which identifies the branches taken while traversing the spatial index with the first ray.

10. The computer readable medium of claim 9, wherein the spatial index is a kd-tree, and wherein the branch history table comprises a series of bit locations which correspond to node levels within the kd-tree.

11. The computer readable medium of claim 10, wherein populating a branch history table comprises:
placing a first in a bit location which indicates a left branch was taken from a corresponding node level; and
placing a second in a bit location which indicates a right branch was taken from a corresponding node level.

12. The computer readable medium of claim 9, wherein the operations further comprise:
recording a history of traversal of the second ray.

13. The computer readable medium of claim 12, wherein recording a history of traversal of the second ray comprises updating the branch history table to reflect the branches taken while traversing the spatial index with the second ray.

14. The computer readable medium of claim 8, wherein pre-fetching information defining bounding volumes comprises retrieving the information from memory and placing the information into local data registers of a processing element.

15. A system, comprising:
a memory; and
a processing element configured to:
issue an first ray into a three dimensional scene;
traverse a spatial index having nodes defining bounded volumes of the three dimensional scene by taking branches from internal nodes until a leaf node is reached, wherein branches are taken based on whether the first ray intersects bounding volumes defined by the nodes;
record a history of traversal of the first ray;
issue a second ray into the three dimensional scene;
pre-fetch from memory information defining bounded volumes intersected by the first ray based on the history of traversal of the first ray; and
traverse the spatial index by taking branches from internal nodes until a leaf node is reached, wherein branches are taken based on whether the second ray intersects bounding volumes defined by the nodes.

16. The system of claim 15, wherein recording the history of traversal of the first ray comprises:
with the processing element, populating a branch history table which identifies the branches taken while traversing the spatial index with the first ray;

17. The system of claim 16, wherein the spatial index is a kd-tree; and
wherein the branch history table comprises a series of bit locations which correspond to node levels within the kd-tree.

18. The system of claim 17, wherein populating a branch history table comprises:
with the processing element, placing a first value in a bit location which indicates a left branch was taken from a corresponding node level; and
with the processing element, placing a second value in a bit location which indicates a right branch was taken from a corresponding node level.

19. The system of claim 16, wherein the processing element is further configured to:
record a history of traversal of the second ray.

20. The system of claim 19, wherein recording a history of traversal of the second ray comprises:
with the processing element, updating the branch history table to reflect the branches taken while traversing the spatial index with the second ray.

21. A method of traversing a tree structure having nodes, comprising:
during a first traversal, traversing the tree structure by taking branches from nodes until a leaf node is reached, wherein branches are taken based on whether conditions defined by nodes are satisfied;
recording a history of traversal of the spatial index; and
during a second traversal, pre-fetching information defining nodes based on the recorded history of traversal of the spatial index, and traversing the tree structure by taking branches from nodes until a leaf node is reached, wherein branches are taken based on whether conditions defined by nodes are satisfied.
